(19) United States
(12) Patent Application Publication
(10) Pub. No.: US 2017/0217137 A1
(43) Pub. Date: Aug. 3, 2017

(54) POLYMER-GLASS-POLYMER GAS BARRIER LAMINATE

(71) Applicants: Asher Vitner, Jerusalem (IL); Matti Ben-Moshe, Reut (IL); Hila Mizrachi, Jerusalem (IL); Michael Keyfetz, Jerusalem (IL)

(72) Inventors: Asher Vitner, Jerusalem (IL); Matti Ben-Moshe, Reut (IL); Hila Mizrachi, Jerusalem (IL); Michael Keyfetz, Jerusalem (IL)

(21) Appl. No.: 15/326,082

(22) PCT Filed: Jul. 15, 2015
(86) PCT No.: PCT/IL2015/050731

§ 371 Date: Jan. 13, 2017

Related U.S. Application Data
(60) Provisional application No. 62/025,047, filed on Jul. 16, 2014.
(60) Provisional application No. 62/053,153, filed on Sep. 21, 2014.

(51) Int. Cl. B32B 27/08; B32B 37/12; B32B 7/12; B32B 27/36; C09D 1/04; B05D 1/42; B05D 3/02; B32B 37/16; C09D 11/02; B32B 38/00; B32B 27/32

(52) U.S. Cl. CPC B32B 27/08; B32B 38/145; B32B 37/12; B32B 7/12; B32B 27/36; B32B 27/32; B05D 1/42; B05D 3/0272; B32B 37/16; C09D 11/02; C09D 1/04; B32B 2307/412; B32B 2307/7244; B32B 2255/10; B32B 2255/20; B32B 2255/26; B32B 2250/24; B32B 2250/02; B32B 2323/00; B32B 2367/00; B32B 2553/00

(57) ABSTRACT

The invention provides a transparent gas barrier polymer-glass-polymer laminated film comprising a first polymeric film substrate; a silicate glass layer, comprising silica and a salt of a monovalent cation other than Lithium, in combination with at least one additive selected from organo-silanes or an epoxy silane precursor, laminated onto said first polymeric film substrate; and a second polymeric film laminated on said glass layer; wherein the oxygen transmission rate through the laminated polymer-glass-polymer film is lower than 0.2 cc/m²/day and methods for the production thereof.

### RELATED APPLICATION

This application is a 35 U.S.C. §371 national stage of PCT International Patent Application No. PCT/IL2015/050731 filed Jul. 15, 2015, which claims priority to U.S. Provisional Patent Application No, 62/025,047 filed July 16, 2014 and Canadian Patent Applications No. 2,834,565 filed Nov. 28, 2013 and No. 62/053,153 filed Sep. 21, 2014, the entire disclosure of each such application being expressly incorporated herein by reference.

### FIELD OF THE INVENTION

The present invention relates to a transparent gas barrier polymer-glass-polymer laminated film and to a method for producing the same. More particularly the present invention relates to a transparent gas barrier polymer-glass-polymer laminated film wherein the oxygen transmission rates through the polymer-glass-polymer laminated film is lower than 0.2 cc/m²/day.

### BACKGROUND

There is an ongoing requirement to improve the impermeability of polymeric materials in order to reduce gas, vapor and liquid permeability. The food packaging industry demands that polymer films should provide a defined barrier against permeation of oxygen, moisture and aroma, i.e. should have a very low OTR. The OTR (oxygen transmission rate) is the steady state rate at which oxygen gas permeates through a film at specified conditions of temperature and relative humidity. OTR values are expressed in cc/m²/day in metric (SI) units. Standard test conditions are 23° C. and 0% RH. Air is composed of about 21% oxygen and 79% nitrogen, with very small concentrations of other gases such as carbon dioxide and argon. Oxygen gas is a reactive compound responsible for fbod spoilage. Many chemical and biological reactions require oxygen in order to occur. In food packaging reduction of oxygen exposure extends the shelf life of oxygen-sensitive products.

The transparent or semi-transparent gas barrier films available in the market today, are Saran coated PET films (OTR˜3-15 cc/m²/day), metalized aluminum polymer films (OTR˜0.1-0.2 cc/m²/day), EVOH coated films (OTR˜0.2 cc/m²/day), electron beam coated. SiO₂ on polymeric films (OTR˜0.05-0.2 cc/m²/day) and polymeric coated films embedded with clay nanoparticles (OTR˜0.4-0.8 cc/m²/day). A transparent polymeric film is a polymer sheet which is transparent to light having a wavelength within the spectral range of 390 to 700 nanometers.

Soluble silicates, such as sodium., potassium, lithium and ammonium silicates are chemical substance glasses or aqueous solutions of glasses, resulting from combinations of alkali metal oxide or ammonium hydroxide and silica in varying proportions. All of the above soluble silicates are alkaline substances (pH values of the concentrated products being usually 10-13). Soluble silicates are produced as aqueous solutions.

Silicates react rapidly when the pH of liquid silicate is lowered below pH--11. Silicate species are crosslinked to form silicate polymers. The reaction proceeds rapidly with acidic species and carbon dioxide to form silicate polymers and a carbonate salt. Examples for this are acidic salts, organic acids, esters or carbonates. The formed carbonate salts tend to scatter light due to crystallization during the drying process (efflorescence).

Silicates are characterized by the weight ratio of silica to oxide. For example dissolved sodium silicates are commercially produced in the ratio range of 1.5 to 3.2 (SiO₂:Na₂O). This ratio represents an average of various molecular weight silicate species (such as monomers, trimers, tetramers etc.). The higher ratio (for example 3.2) is a low alkali content that is more readily neutralized and allows quicker polymerization/aggregration.

Glass coating on polymeric articles may provide a way to improve gas and liquid barrier properties. Among methods used to deposit glass on polymers are the chemical routes that use chemical or physical vapor deposition, ion beam, sol-gel chemistry and alkali silicate chemistry. Alkali metal polysilicates are known as protective coatings that modify the surface properties of polymeric films and other articles; See for example GB1007482; GB1424425; U.S. Pat. No. 1,949,914; U.S. Pat. No. 3 1,020,38; U.S. Pat. No. 3,130,061; U.S. Pat. No. 3,180,747; U.S. Pat. No. 3,492,137; U.S. Pat. No. 3,522,066; U.S. Pat. No. 3,533,816 and U.S. Pat. No. 3,706,603.

Alkali silicates react with carbon dioxide to form alkali carbonates. Sodium silicates tend to react with carbon dioxide to form sodium carbonates and become progressively less water-soluble while Potassium silicate films are less likely than sodium silicate to develop a carbonate bloom or white efflorescent coat of alkali carbonate.

Also, polymeric articles are known to become hazy after silicate coatings are incorporated therein. The tendency of sodium (Na) silicate coatings to effloresce or to become covered by powdery crystalline material as a result of atmospheric exposure has been well documented (see for example: Properties of soluble silicates, Weldes H. Helmut and K. Robert Lange, Industrial and Engineering Chemistry, Volume 61(4), pages 28--44, 1969).

Several patents propose using Lithium silicate based gas barrier coatings for a variety of polymeric surfaces. For example, Hecht and Ilex, Canadian Patent No. 993,738, describe a gas and liquid-impermeable coating for polymeric substrates comprising lithium polysilicate having a certain mole ratio of SiO2 to Li₂O of about 1.6 to 4.6.

U.S. Pat. No. 2,998,328 discloses the addition of titanium dioxide pigment and describes a finish or overcoat comprising a reactive liquid component comprising an aqueous solution of an alkali metal silicate and a pigmented blending component. The reactive liquid component dissolves an alkali metal silicate such as sodium silicate, potassium silicate, lithium silicate, or a mixture of such silicates in water.

U.S. Pat. No. 5,882,798 and U.S. Pat. No. 6,071,624 (A) disclose a mixture composition of alkali silicates in order to improve characterization of the coating layer, using Lithium and potassium copolysilicate coatings of the formula (M₂O)(SiO₂)_{Y}, wherein M₂O is (Li₂O)ₓ (K₂O)1-x and wherein x ranges from 0.5 to less than 1, and y ranges from 1 to about 10, said solution comprising about up to 15% total solids content in order to improve permeability.

U.S. Pat. No. 6,071,624 discloses an aqueous barrier coating composition for polymeric substrates. This patent describes that the use of potassium silicate is required together with lithium and sodium silicate because lithium and sodium silicate coatings tend to effloresce, i.e., become covered by powdery crystalline material as a result of atmospheric exposure. This patent also describes the use of poly(p-hydroxystyrene) in 0.1 N aqueous lithium hydroxide as a priming solution.

However, where the matter being packaged is a foodstuff or pharmaceutical, it will normally be preferred that the plastics film or other substrate should be a food grade plastic. Lithium coatings may limit the usage in such applications. For example: European legislation as presented in Union Guidelines on Regulation (EU) No 10/2011 on plastic materials and articles intended to come into contact with food limit the migration limits of Lithium to 0.6 mg/Kg material.

GB2447221 (A) discloses a composition comprising a metal silicate dispersed throughout a film of a water-soluble film-forming acrylic solution polymer. The ratio of metal silicate to acrylic solution polymer may be 99:1 to 4:1. A composition for forming a gas barrier coating is also disclosed, which comprises a solution of a metal silicate and a water-soluble, film-forming acrylic solution polymer in a solvent. However, a problem with known glass films on polymeric substrates is that the inorganic silicate layer of these disclosed coatings is brittle and tends to crack or delaminate when the polymer is flexed, mainly due to the weak bonding forces to the polymer substrate, leading to poor gas and vapor impermeability properties.

A proposed route to overcome the brittleness problems is incorporation of nanoparticles and/or polymer solution or emulsion into the silicate coating.

EP2195390A1 relates to gas barrier coatings, having, in particular, the ability to block the passage of oxygen, said composition comprising a water-soluble metal silicate; a clay; and a polymer emulsion; the silicate comprising at least 70% by weight of the solids in the composition, and the clay and polymer each comprising at least 1% by weight of the total solids in the composition. The use of clay in combination with the metal silicates was also reported in JP2001260264 and GB2452718.

GB1068584 discloses a water based siliceous coating composition comprising at least one water soluble alkali silicate having a molar ratio SiO₂/M₂O of at least 3 wherein M is K or Na, and a combined water content of at least 18% by weight, at least one filler and/or one pigment and at least one film forming colloidal binder which is soluble in silicate solutions.

US2002168477 (A1) discloses a silicate coating composition comprising an aqueous dispersion containing zinc particles. The binder agent for the composition is a mixture of sodium silicate or potassium silicate with sufficient lithium polysilicate.

EP0906374 B1 discloses transparent barrier coatings for a polymeric article comprising a poly(ethylene terephthalate) polymeric substrate having an inorganic barrier layer which is substantially transparent at a thickness of less than 500 nm and which is prepared from a solution comprising an alkali metal poly silicate and nano crystalline titanium dioxide, U.S. Pat. No. 5,853,830 also refers to a coating solution comprising a metal polysilicate solution and nano-crystalline titanium dioxide.

EP2252652 A1 discloses a hydrophilic antifog composition comprising an alkali metal silicate, a wetting agent, and a hydrophilic antifog agent.

Also, there remains a need in the art of barrier coatings for coating compositions and methods which overcome the above deficiencies, and provide a good vapor, gas and/or aroma barriers for polymeric packaging products

### SUMMARY

With this state of the art in mind there is now provided according to the present invention a transparent gas barrier polymer-glass-polymer laminated film comprising;

a. a first polymeric film substrate;

b. a silicate glass layer, comprising silica and a salt of a monovalent cation other than Lithium, in combination with at least one additive selected from organo-silanes or an epoxy silane precursor, laminated onto said first polymeric film substrate; and

c. a second polymeric film laminated on said glass layer;

wherein the oxygen transmission rate through the laminated polymer-glass-polymer film is lower than 0.2 cc/m²/day.

Preferably, the haze of the laminated polymer-glass-polymer film is lower than 1%.

In preferred embodiments, said silicate glass layer is formed by printing and curing at least two layers of a silicate salt ink onto said first polymeric film substrate;

Preferably, said monovalent cation is selected from the group consisting of sodium, potassium, ammonium and any of a combinations thereof.

In preferred embodiments, said transparent gas barrier polymer-glass-polymer laminated film further comprises inorganic phosphate salts selected from monopotassium phosphate, monosodium phosphate, monoammonium phosphate, dipotassium phosphate, disodium phosphate, tripotassium phosphate, trisodium phosphate, Sodium Hexametaphosphate, sodium tripolyphosphate, ammonium tripolyphosphate, potassium tripolyphosphate, Sodium Pyrophosphate, Tricalcium Phosphate and combinations thereof.

Preferably, the transparency of the polymer-glass-polymer laminated film is higher than 60% in the visible spectral region of 390-700 nm.

In preferred embodiments of the present invention the transparency of the polymer-glass-polymer laminate is higher than 80% for light in the visible spectral region of 390-700 nm.

In preferred embodiments, said salt of a monovalent cation is selected from the group of carbonate, acetate, fumarate salts or any of a combination thereof.

Preferably, the second polymeric film comprises at least one thermoplastic polymer selected from polyesters, polycarbonates, polyarylates, polyolefins, polyurethanes, polyacrylics, polyamides, epoxides, silicons, polysulfides, chlorinated rubbers, phenolics, polyvinyls and copolymers thereof.

In another aspect of the present invention, there is provided a method for producing a polymer-glass-polymer laminated gas barrier film comprising;
printing and drying at least 2 layers of a glass ink formulation comprising a silicate salt comprising a monovalent cation other than Lithium, onto a first polymeric film substrate;
curing said printed glass layers on the first polymeric film substrate to form a silicate glass coating on said first polymeric film substrate; and

laminating the cured glass coated polymeric substrate with a second polymeric film to form said polymer-glass-polymer laminated gas barrier film;

wherein the oxygen transmission rates through the polymer-glass-polymer laminated film is lower than 0.2 cc/m²/day.

Preferably, the glass layer is directly printed.

Optionally, the glass layer is directly printed either by using a non-contact or a contact printing method.

In another embodiment, the printed glass layer thickness and binding to the polymeric substrate enables a flexible laminate.

In preferred embodiments of the invention, said printing method is selected from screen printing, roller coating, spray coating, curtain coating, dip coating, gravure, inkjet printing or flexographic printing and combinations thereof.

In another embodiment, the polymeric substrate is treated in a known and conventional manner, e,g., by flame, plasma, or corona discharge to improve its receptivity to inks and/or its suitability for such subsequent manufacturing operations, such as lamination.

In preferred embodiments the glass layer has a thickness of less than 30 micrometers,preferably less than 20, more preferable less than 10 micrometers and even more preferable less than 5 microns.

In another embodiment, the glass layer is printed at least two times with drying between the printing cycles. In yet another embodiment, the glass layer is printed at least two times with drying and curing between the printing cycles.

In another embodiment, the glass layer is cured in a carbon dioxide rich atmosphere or organic or inorganic acidic atmosphere.

In preferred embodiment, an organosilane or epoxysilane is added to the formulation so as to reduce cracking and lower the gas permeability of the silicate layer after curing. The organosilane or epoxysilane is selected from the group consisting of 3-aminopropyl-triethoxy-silane, 3-glycidoxy-propyl-trimetheoxysilane, p-aminophenyl-silane, allyltrimethoxysilane, n-(2-aminoethyl)-3-amino-propyl-tri-methoxy-silane, 3-amino-propyl-tri-ethoxy-silane, 3-amino-propyl-trimethoxy-silane, 3 -glycidoxy-propyl-di-isopropyl-ethoxy-silane, (3-glycidoxypropypmethyl-di-ethoxy-silane, 3-mercapto-propyl-trimethoxy-silane, 3-mercapto-propyl-triethoxy-silane, 3-methacryloxy-propyl-methyl-di-ethoxy-silane, 3-methacryloxy-propyl-methyl-di-methoxy-silane, 3-methacryloxy-propyltri-methoxy-silane, n-phenyl-amino-propyl-tri-methoxy-silane, vinyl-methyl-di-ethoxy-silane, vinyl-tri-ethoxy-silane, methoxy-silane, 3-glycidoxypropyl-trimethoxysilane, beta-(3,4-epoxy-cyclo-hexyl)-ethyl-tri-methoxy-silane, 3-glycidoxy-propyl-methyl-di-ethoxy-silane and 2-glycidoxy-propyl-tri-methoxy-silane and mixtures thereof.

In preferred embodiments, said first polymeric film comprises at least one thermoplastic polymer selected from polyesters, polycarbonates, polyarylates, polyolefins, polyurethanes, polyacrylics, polyamides, epoxides, silicons, polysulfides, chlorinated rubbers, phenolics, polyvinyls and copolymers thereof.

Preferably the laminate is fabricated by depositing an adhesive resin layer on at least one of the glass layer and the second polymer film

In preferred embodiments, the second polymeric film comprises at least one thermoplastic polymer selected from polyesters, polycarbonates, polyarylates, polyolefins, polyurethanes, polyacrylics, polyamides, epoxides, silicons, polysulfides, chlorinated rubbers, phenolics, polyvinyls and copolymers thereof.

Preferably the adhesive is based on polyethylene, polyurethane, acrylic, methacrylic, epoxy, vinyl butyral (PVB), a ethylene vinyl acetate (EVA) or ethylene vinyl hydroxide (EVOH).

In a further aspect of the present invention, there is provided a glass ink use for preparing the laminated film define above, wherein said silicate salt is selected from the group consisting of sodium silicate, potassium silicate, ammonium silicate and combinations thereof.

Preferably, the glass ink further comprises at least one additive selected from an inorganic phosphate salt, organo-silanes, epoxy silane precursor and combinations thereof.

In preferred embodiments, said organo silane or epoxy silane additive is thermally hydrolyzed prior or after being added to the ink formulation.

In preferred embodiments of the present invention, said glass ink comprises at least 20% silicate salt by weight, wherein the surface tension of the ink is lower than 40 dynes/cm.

In especially preferred embodiments the surface tension of the ink is lower than 35 dynes/cm.

Preferably, said glass ink further comprises phosphate salts selected from monopotassium phosphate, monosodium phosphate, monoammonium phosphate, dipotassium phosphate, disodium phosphate, tripotassium phosphate, trisodium phosphate, Sodium Hexametaphosphate, sodium tripolyphosphate, ammonium tripolyphosphate, potassium tripolyphosphate, Sodium Pyrophosphate, Tricalciurn Phosphate and combinations thereof.

In especially preferred embodiments of the present invention, the turbidity of the ink is lower than 0.2 at 600 nm (1 cm optical path).

In preferred embodiments of the present invention the first polymeric film comprises one or more thermoplastic polymers selected from polyesters, polycarbonates, polyarylates, polyolefins, polyurethanes, polyacrylics, polyamides, epoxides, silicons, polysulfides, chlorinated rubbers, phenolics, polyvinyls or any copolymers thereof.

In a preferred embodiment, the laminate is fabricated by depositing an adhesive resin layer on the glass layer, on the second polymer film or on both.

In another embodiment the second polymer film is deposited in situ as a polymer resin on the printed glass layer to form the second polymeric film.

In another embodiment, the laminated film has an oxygen transmission rate which is lower than 0.05 cc/m²/day and even more preferably lower than 0.01 cc/m²/day and most preferably, 0.001 cc/m²/day or even lower.

In another embodiment, the glass layer is printed more than three times, more than four times or more than 5 times, so as to lower the gas permeability to even lower values.

In another embodiment, of the present invention, the second polymeric film comprises one or more thermoplastic polymers selected from polyesters, polycarbonates, polyarylates, polyolefins, polyurethanes, polyacrylics, polyamides, epoxides, silicons, polysulfides, chlorinated rubbers, phenolics, polyvinyls or any copolymers thereof.

Preferably said second polymeric film comprises polyethylene, polylactic acid, a polyester or a combination thereof

In another embodiment, the adhesive is based on polyethylene, polyurethane, acrylic, epoxy, vinyl butyral (PVB), ethylene vinyl acetate (EVA) or ethylene vinyl hydroxide (EVOH).

In another embodiment, the silicate glass coating further comprises metal oxide nanoparticles.

In another embodiment, the glass layer has a refractive index within less than 0.1 refractive index units to the refractive index of the first polymer substrate.

Optionally the silicate glass layer farther comprises at least one pigment or a coloring substance.

While the invention will now be further described in connection with certain particular embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples will serve to illustrate the practice of this invention, it is to be understood that the particulars shown are by way of example and for purposes of illustrative discussion of particular embodiments of the present invention only and are presented in the cause of providing what is believed to be the most useful and readily understood description of formulation procedures as well as of the principles and conceptual aspects of the invention.

### DETAILED DESCRIPTION OF EXAMPLES

Reference is now made to the following examples, which together with the above description illustrate the invention in a non-limiting fashion.

### MATERIALS USED IN EXAMPLES

The following materials are used in exemplary formulations described in examples herein below: 36 micron (SH37), 45 micron (SP 18A), 50 micron (SG55C), 75 micron P.P.C. PET film and 100 microns P.P.C. PET films were supplied by SKC (Skyrol brand, SKC co. Ltd., Korea) and Jolybar ltd. (Israel). Silica sol was supplied as 30% colloidal dispersion in water, available from Alfa Aesar; SNOWTEX® ST-40 is colloidal silica particle dispersions available from Nissan Chemical, America Corporation, Houston, Tex. USA; PVA refers to Mowiol® 4-98 Mw˜27,000 available from Sigma Aldrich; epoxy silane refers to Z-6040 Silane Glycidoxypropyltrimethoxysilane available from Dow corning; Sodium phosphate is available from Sigma Aldrich ; PEI refers to Polyethylene imine, which is available from Bio lab Ltd, Israel; Ethylene glycol is available from Bio lab Ltd, Israel; hexadecyltrimethylammonium bromide; glycerol are both available from Sigma Aldrich; Potassium Silicate and Sodium silicate are available from Provetro gruppe,

Schlofβ Holte, Germany.

### Comparative Example 1

A 75 micron PET film was laminated by POUCH LAMINATOR PDA3-330L using PE film (80 micron thick) at 150° C. Its OTR was 13.6 cc/m²/day.

### Example 2

An ink formulation was prepared according to the following procedure; 10% epoxy silane was added to 90% sodium silicate (40% solid), it was applied on a PET film by an applicator bar at 24 micron wet thickness (Wire-wound Rod, BYK-Gardner, Germany). A continuous film was formed upon curing at 90° C. in a convection furnace. After 5 minutes in room temperature a second layer was applied and a 3^{rd} layer as well. The resulting film was laminated by POUCH LAMINATOR PDA3-330L with PE film (80 micron thick) at 150° C. Its OTR was 0.038 cc/m²/day.

### Example 3

An ink formulation was prepared according to the following procedure and with the following components; 4.1% epoxy silane, 32.7% sodium silicate, 2.0% Na5P3O10 and the remaining water. The ink was applied on a PET film by an applicator bar at 24 micron wet thickness (Wire-wound Rod, BYK-Gardner, Germany). A continuous film was formed upon curing at 90° C. in a convection furnace. After 5 minutes in room temperature a second layer was applied and a 3^{rd} layer as well. The resulting film was laminated by POUCH LAMINATOR PDA3-330L with PE film (80 micron thick) at 150° C. Its OTR was 0.001 cc/m²/day.

### Example 4

An ink formulation was prepared according to the following procedure and with the following components: 1.9% glucose, 32.8% sodium silicate, 4.1% epoxy silane and the remain water, The composition was applied on a PET sheet, at 24 micron wet thickness by an applicator bar (Wire-wound Rod, BYK-Gardner, Germany) in 3 layers. Each layer was cured at 90° C. in a convection furnace forming a continuous film. The resulting film was laminated by POUCH LAMINATOR PDA3-330L with PE film (80 micron thick) at 150° C. OTR=0.06 cc/m²/day.

### Example 5-8

Ink formulations were prepared using various compositions (as listed in table 1) of sodium silicate and epoxy silane. compositions were applied on PET film by an applicator bar, 24 micron wet thickness (Wire-wound Rod, BYK-Gardner, Germany) in 3 layers. A continuous film was formed upon curing at 90° C. in a convection furnace. The resulting film was laminated by POUCH LAMINATOR PDA3-330L with PE film (80 micron thick) at 150° C.

TABLE 1
Examples 5-8

| | Sodium silicate, | Epoxy silane, | | |
|---|---|---|---|---|
| | wt % | wt % | H₂O | OTR |
| Example 5 | 39.6 | 0.5 | 59.9 | 0.039 |
| Example 6 | 37.9 | 2.6 | 59.5 | 0.014 |
| Example 7 | 36.4 | 4.5 | 59.1 | 0.13 |
| Example 8 | 32 | 10 | 58 | 0.06 |

### Example 9-11

An ink formulation was prepared using various compositions (as listed in table 2) of sodium silicate, epoxy silane and sodium triphosphate, compositions were applied on PET film by an applicator bar, 24 micron wet thickness (Wire-wound Rod, BYK-Gardner, Germany) in 3 layers. A continuous film was formed upon curing at 90° C. in a convection furnace. The resulting film was laminated by POUCH LAMINATOR PDA3-330L with PE film (80 micron thick) at 150° C.

TABLE 2
Examples 9-11

| | Sodium | Epoxy | | | |
|---|---|---|---|---|---|
| | silicate, | silane, | | sodium | |
| | wt % | wt % | H₂O | triphosphate | OTR |
| Example 9 | 34.5 | 4.3 | 60.1 | 1.0 | 0.285 |
| Example 10 | 29.1 | 3.6 | 63.3 | 4.0 | 0.06 |
| Example 11 | 32.7 | 4.1 | 61.2 | 2.0 | 0.001 |

### Example 12-16

An ink formulation was prepared using compositions of sodium silicate, epoxy silane and sodium triphosphate. The mol ratio of the sodium silicate achieved by mixing different liquid glass with 3.2 and 1.6 mol ratio. compositions were applied on PET film by an applicator bar, 24 micron wet thickness (Wire-wound Rod, BYK-Gardner, Germany) in 3 layers. A continuous film was formed upon curing at 90° C. in a convection furnace. The resulting film was laminated by POUCH LAMINATOR PDA3-330L with PE film (80 micron thick) at 150° C.

TABLE 3
Examples 12-16

| | Sodium | Epoxy | | | |
|---|---|---|---|---|---|
| | silicate, | silane, | | Mol | |
| | wt % | wt % | H₂O | ratio | OTR |
| Example 12 | 40 | 4.5 | 55.5 | 1.6 | 0.039 |
| Example 13 | 37 | 4.5 | 58.4 | 2.4 | 0.16 |
| Example 14 | 35.6 | 4.5 | 59.9 | 2.8 | 0.061 |
| Example 15 | 33.6 | 4.5 | 61.8 | 3.2 | 0.1 |

### Example 16

An ink formulation was prepared using the compositions listed in table 4 of sodium silicate, epoxy silane and sodium triphosphate. Ink was applied on a PET film by an applicator bar, 24 micron wet thickness (Wire-wound Rod, BYK-Gardner, Germany) in 3 layers. A continuous film was formed upon curing at 90° C. in a convection furnace. The resulting film was laminated by POUCH LAMINATOR PDA3-330L with PE film (80 micron thick) at 150° C.

TABLE 4
Example 16

| | Sodium, | Potassium | | Epoxy | |
|---|---|---|---|---|---|
| | silicate, | silicate, | | silane, | |
| | wt % | wt % | H₂O | wt % | OTR |
| Example 16 | 27.9 | 20.3 | 46.8 | 5 | 0.029 |

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

What is claimed is:

1. A transparent gas barrier polymer-glass-polymer laminated film comprising;
a. a first polymeric film substrate;
b. a silicate glass layer, comprising silica and a salt of a monovalent cation other than Lithium, in combination with at least one additive selected from organo-silanes or an epoxy silane precursor, laminated onto said first polymeric film substrate; and
c. a second polymeric film laminated on said glass layer;
wherein the oxygen transmission rate through the laminated polymer-glass-polymer film is lower than 0.2 cc/m²/day.

2. A transparent gas barrier polymer-glass-polymer laminated film according to claim 1, wherein the haze of the laminated polymer-glass-polymer film is lower than 1%.

3. A transparent gas barrier polymer-glass-polymer laminated film according to claim 1, wherein said silicate glass layer is formed by printing and curing at least two layers of a silicate salt ink onto said first polymeric film substrate.

4. A transparent gas barrier polymer-glass--polymer laminated film according to claim 1 wherein said monovalent cation is selected from the group consisting of sodium, potassium, ammonium and any of a combinations thereof.

5. A transparent gas barrier polymer-glass-polymer laminated film according to claim 1, further comprising inorganic phosphate salts selected from monopotassium phosphate, monosodium phosphate, monoammonium phosphate, dipotassium phosphate, disodium phosphate, tripotassium phosphate, trisodium phosphate, Sodium Hexametaphosphate, sodium tripolyphosphate, ammonium tripolyphosphate, potassium tripolyphosphate, Sodium Pyrophosphate, Tricalcium Phosphate and combinations thereof.

6. The laminated film according to claim 1, wherein the transparency of the polymer-glass-polymer laminated film is higher than 60% in the visible spectral region of 390-700 nm.

7. The laminated film according to claim 1 wherein said salt of monovalent cation is selected from the group of carbonate, acetate, fumarate salts or any of a combination thereof.

8. The laminated film according to claim 1, wherein the second polymeric film comprises at least one thermoplastic polymer selected from polyesters, polycarbonates, polyarylates, polyolefins, polyurethanes, polyacrylics, polyamides, epoxides, silicons, polysulfides, chlorinated rubbers, phenolics, polyvinyls and copolymers thereof.

9. A method for producing a polymer-glass-polymer laminated gas barrier film comprising;
printing and drying at least 2 layers of a glass ink formulation comprising a silicate salt comprising a monovalent cation other than Lithium, onto a first polymeric film substrate;
curing said printed glass layers on the first polymeric film substrate to form a silicate glass coating on said first polymeric film substrate; and
laminating the cured glass coated polymeric substrate with a second polymeric film to form said polymer-glass-polymer laminated gas barrier film;
wherein the oxygen transmission rates through the polymer-glass-polymer laminated film is lower than 0.2 cc/m²/day.

10. The method according to claim 9, wherein the glass layer is directly printed.

11. The method according to claim 9 wherein said printing method is selected from screen printing, roller coating, spray coating, curtain coating, dip coating, gravure, inkjet printing or flexographic printing and combinations thereof.

12. The method according to claim 9, wherein the glass layer has a thickness of less than 30 micrometers.

13. The method according to claim 9, wherein the first polymeric film comprises at least one thermoplastic polymer selected from polyesters, polycarbonates, polyarylates, polyolefins, polyurethanes, polyacrylics, polyamides, epoxides, silicons, polysulfides, chlorinated rubbers, phenolics, polyvinyls and copolymers thereof.

14. The method according to claim 9, wherein the laminate is fabricated by depositing an adhesive resin layer on at least one of the glass layer and the second polymer film.

15. The method according to claim 9, wherein the second polymeric film comprises at least one thermoplastic polymer selected from polyesters, polyearbonates, polyarylates, polyolefins, polyurethanes, polyacrylics, polyamides, epoxides, silicons, polysulfides, chlorinated rubbers, phenolics, polyvinyls and copolymers thereof.

16. The method according to claim 9, wherein the adhesive is based on polyethylene, polyurethane, acrylic, methacrylic, epoxy, vinyl butyral (PVB), a ethylene vinyl acetate (EVA) or ethylene vinyl hydroxide (EVOH).

17. A glass ink used for preparing the laminated film of claims 9-16, wherein said silicate salt is selected from the group consisting of sodium silicate, potassium silicate, ammonium silicate and combinations thereof.

18. A glass ink according to claim 17, wherein the glass ink further comprises at least one additive selected from an inorganic phosphate salt, organo-silanes, epoxy silane precursor and combinations thereof.

19. A glass ink according to claim 17 wherein said organo silane or epoxy silane additive is thermally hydrolyzed prior or after being added to the ink formulation.

20. A glass ink according to claim 17 comprising at least 20% silicate salt by weight, wherein the surface tension of the ink is lower than 40 dynes/cm.

21. A glass ink according to claim 17 used for preparing the laminate of claim 1 further comprising inorganic phosphate salts selected from monopotassium phosphate, monosodium phosphate, monoammonium phosphate, dipotassium phosphate, disodium phosphate, tripotassium phosphate, trisodium phosphate, Sodium Hexametaphosphate, sodium tripolyphosphate, ammonium tripolyphosphate, potassium tripolyphosphate, Sodium Pyrophosphate, Tricalcium Phosphate and combinations thereof.

22. A glass ink according to claim 17, whereas the turbidity of the ink is lower than 0.2 at 600 nm (1 cm optical path).
